(19) United States
(12) Patent Application Publication
(10) Pub. No.: US 2023/0116754 A1
(43) Pub. Date: Apr. 13, 2023

(54) BATTERY COOLING STRUCTURE

(71) Applicant: HONDA MOTOR CO., LTD., Tokyo (JP)

(72) Inventors: Jaewon SON, Tokyo (JP); Hiroshi KANO, Tokyo (JP); Hiroki SAKAMOTO, Tokyo (JP); Tetsuya SUGIZAKI, Tokyo (JP); Ryo SHINODA, Tokyo (JP)

(21) Appl. No.: 17/931,553

(22) Filed: Sep. 13, 2022

(30) Foreign Application Priority Data
Oct. 8, 2021 (CN) 202122415342.8

(51) Int. Cl. H01M 10/613; H01M 10/6566; H01M 10/647; H01M 10/625; H01M 50/209

(52) U.S. Cl. CPC H01M 10/613; H01M 10/6566; H01M 10/647; H01M 10/625; H01M 50/209; H01M 2220/20

(57) ABSTRACT

The battery cooling structure includes a cell stacked body that has an inter-cell flow path between adjacent battery cells, a base plate that is disposed adjacent to one of surfaces of the cell stacked body, an inflow-side flow path that is disposed between the cell stacked body and the base plate and communicates with the inter-cell flow path, and an air supply port that is disposed in one end portion of the inflow-side flow path in the stacking direction and supplies air to the inflow-side flow path are included. The base plate has a branching portion that branches air in the inflow-side flow path, into a plurality of flows, and the branching portion is disposed at a position that is further from the air supply port than one endmost battery cell of the cell stacked body, the one endmost battery cell being adjacent to of the air supply port.

This application is based on and claims the benefit of priority from Chinese Utility Model Application No. 202122415342.8, filed on 8 Oct. 2021, the content of which is incorporated herein by reference.

### BACKGROUND OF THE INVENTION

### Field of the Invention

The present invention relates to a battery cooling structure.

### Related Art

In the related art, a battery cooling structure adapted to cause cooling air to flow through an inter-cell flow path between adjacent battery cells in a cell stacked body in which a plurality of battery cells is stacked is known. The air is supplied from one end portion side in a stacking direction of the battery cells to one surface of the cell stacked body along the stacking direction (see Patent Documents 1 and 2, for example).

Since a direction in which air supplied along the stacking direction of the cell stacked body flows and a direction of air flowing through the inter-cell flow path perpendicularly intersect each other, air does not easily flow into the inter-cell flow path that is close to the air supply side with a high flow rate and high straightness. Therefore, according to a battery cooling structure described in Patent Document 1, a partitioning plate with a gradient is provided inside each of air distribution flow paths having a duct shape and provided on an upper surface and a lower surface of a cell stacked body. In this manner, static pressures of the air inside the distribution flow paths are equalized, and the air is caused to flow into an inter-cell flow path on an air supply side as well, thereby curbing variation in temperatures of battery cells.

According to a battery cooling structure described in Patent Document 2, a plate-shaped flow dividing portion that divides a part of air flow toward an inter-cell flow path is newly provided near an air supply port for each cell stacked body.
Patent Document 1: Japanese Patent No. 6626798
Patent Document 2: Japanese Unexamined Patent Application, Publication No. 2014-135237

### SUMMARY OF THE INVENTION

However, the battery cooling structure described in Patent Document 1 has a disadvantage that the height of the entire battery device increases and the structure becomes complicated since the air distribution flow paths with duct shapes, each of which has the partitioning plate, are provided on the upper surface and the lower surface of the cell stacked body.

For the battery cooling structure described in Patent Document 2, it is necessary to separately provide the flow dividing portion for dividing a part of air flow for each cell stacked body. This leads to a disadvantageous increase in the number of components.

An object of the present invention is to provide a battery cooling structure having a simple configuration and capable of curbing variation in temperatures of battery cells by causing air to flow through an inter-cell flow path on a side of an air supply port as well and thereby improving energy efficiency.

A first aspect of the present invention is directed to a battery cooling structure including: a cell stacked body (for example, a cell stacked body 2 which will be described later) that includes a plurality of battery cells (for example, battery cells 21 which will be described later) stacked on each other and an inter-cell flow path (for example, an inter-cell flow path 22 which will be described later) between the battery cells that are adjacent in a stacking direction (for example, an X direction which will be described later) of the plurality of battery cells; a base plate (for example, a base plate 3 which will be described later) that is disposed adjacent to one of surfaces (for example, a lower surface 2a which will be described later) of the cell stacked body, the surfaces extending along the stacking direction; an inflow-side flow path (for example, an inflow-side flow path 30 which will be described later) that is disposed between the cell stacked body and the base plate and communicates with the inter-cell flow path; and an air supply port (for example, an air supply port 312 which will be described later) that is disposed in one end portion (for example, an end portion on a side of the X1 direction which will be described later) of the inflow-side flow path in the stacking direction and supplies air to the inflow-side flow path. The base plate has a branching portion (for example, a branching portion 32 which will be described later) that branches the air in the inflow-side flow path flowing along the stacking direction from the air supply port, into a plurality of flows. The branching portion is disposed at a position that is further from the air supply port than one endmost battery cell (for example, a battery cell 21a which will be described later) among the battery cells of the cell stacked body, the endmost battery cell being adjacent to the air supply port.

A second aspect of the present invention is an embodiment of the first aspect described above. In the battery cooling structure according to the second aspect, the base plate preferably has a step portion (for example, a step portion 33 which will be described later) that protrudes into the inflow-side flow path toward the cell stacked body, and the step portion is preferably disposed at a position that is further from the air supply port than the branching portion.

A third aspect of the present invention is an embodiment of the first or second aspect described above. In the battery cooling structure according to the third aspect, the cell stacked body preferably comprises a plurality of cell stacked bodies arranged side by side on the base plate, the inflow-side flow path is preferably common to the plurality of cell stacked bodies, and the branching portion is preferably disposed between the cell stacked bodies that are adjacent to each other.

A fourth aspect of the present invention is an embodiment of any one of the first to third aspects described above. Preferably, the battery cooling structure according to the fourth aspect further includes electrical equipment (for example, an IPU 6 which will be described later) that controls an input and an output of the cell stacked body and is disposed opposite to the base plate with respect to the cell stacked body. The electrical equipment is preferably disposed at a position that is closer to the air supply port than the branching portion of the base plate.

A fifth aspect of the present invention is an embodiment of any one of the first to fourth aspects described above. The battery cooling structure according to the fifth aspect is preferably adapted to be installed such that the cell stacked body is positioned opposite to an engine exhaust pipe (for example, an exhaust pipe 200 which will be described later) with respect to the base plate while having the stacking direction intersecting the engine exhaust pipe. The exhaust pipe is preferably disposed at a position that is closer to the air supply port than the branching portion of the base plate.

According to the first aspect, in the inflow-side flow path, a flow path cross-sectional area near the air supply port on an upstream side is larger than a flow path cross-sectional area on a downstream side of the branching portion due to the branching portion provided on the base plate at the position spaced apart from the air supply port. This leads to a decrease in flow rate in the inflow-side flow path near the air supply port and a decrease in pressure loss, thereby causing the air to easily flow into the inter-cell flow paths near the air supply port. The first aspect makes it possible to curb variation in temperatures of the battery cells and thereby to improve energy efficiency with a simple configuration in which the base plate is provided with the branching portion.

According to the second aspect, providing the step portion at the position further from the air supply port than the branching portion makes it possible to improve a situation in which air does not easily flow into the inter-cell flow paths due to peeling-off of airflow occurring near the branching portion and an increase in flow rate caused by a decrease in flow path cross-sectional area. Therefore, air easily flows also into the inter-cell flow path near the branching portion, thereby making it possible to further curb the variation in temperatures of the battery cells.

The third aspect, makes it possible to curb the variation in temperatures of the battery cells for each of the plurality of cell stacked bodies.

The fourth aspect, makes it possible to suitably cool the battery cells disposed at positions close to the air supply port and thereby to reduce an effect of heat exerted on the battery cells even if the electrical equipment, which is a heat generating element, is disposed at a position close to the air supply port.

The fifth aspect makes it possible to suitably cool the battery cells disposed at positions close to the air supply port and thereby to reduce an effect of heat exerted on the battery cells even if the exhaust pipe, which is a heat generating element, is disposed at a position close to the air supply port.

### BRIEF DESCRIPTION OF THE DRAWINGS

FIG. 1 is a plan view illustrating a floor panel of a vehicle including a battery device with a battery cooling structure according to the present embodiment;

FIG. 2 is an exploded perspective view illustrating the battery device;

FIG. 3 is a plan view illustrating a bottom portion upper surface of a base plate in the battery device;

FIG. 4 is a diagram illustrating an end surface of the battery device cut along the line A-A in FIG. 3;

FIG. 5 is a diagram illustrating an end surface of the battery device cut along the line B-B in FIG. 3;

FIG. 6 is a diagram illustrating an end surface of the battery device cut along the line C-C in FIG. 3;

FIG. 7 is a sectional view of the battery device cut along the line D-D in FIG. 3; and

FIG. 8 is a graph illustrating an effect of the battery cooling structure according to the present embodiment.

### DETAILED DESCRIPTION OF THE INVENTION

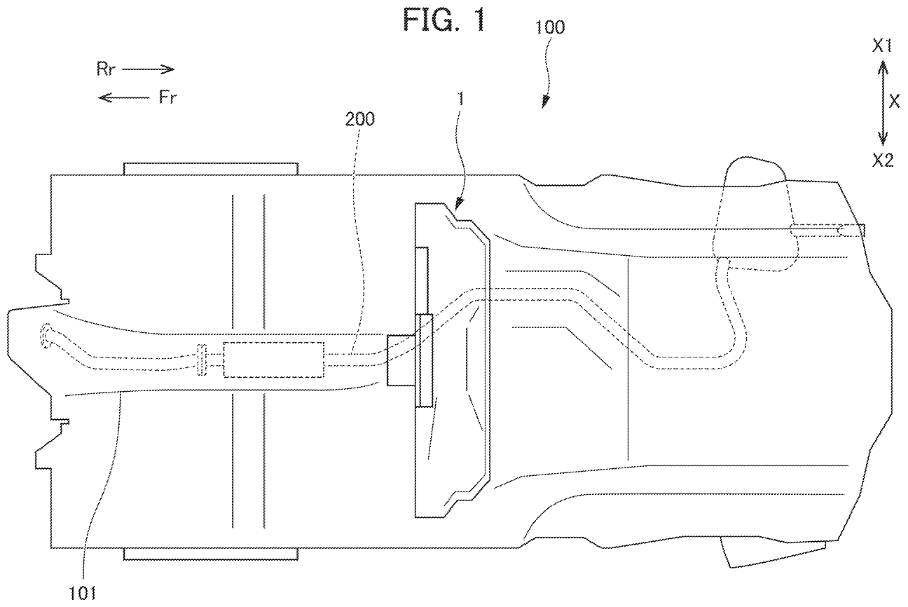

A battery cooling structure according to an embodiment of the present invention will be described in detail with reference to the drawings. FIG. 1 is a plan view illustrating a floor panel 100 of a vehicle. In the floor panel 100, the left side illustrated in the drawing corresponds to a vehicle front side (Fr), and the right side illustrated in the drawing corresponds to a vehicle rear side (Rr). An X direction that follows the up-down direction in the drawing corresponds to a vehicle left-right direction. An X1 direction corresponds to a vehicle right direction, and an X2 direction corresponds to a vehicle left direction, with respect to the vehicle front side.

A battery device 1 is disposed on an upper surface of the floor panel 100 so that the battery device 1 extends in the vehicle left-right direction. The site where the battery device 1 is installed is on the floor panel 100 and below a rear seat (not illustrated) of the vehicle. The battery device 1 is laid directly on the upper surface of the floor panel 100 and is secured to the floor panel 100 with a fastening member such as a bolt (not illustrated).

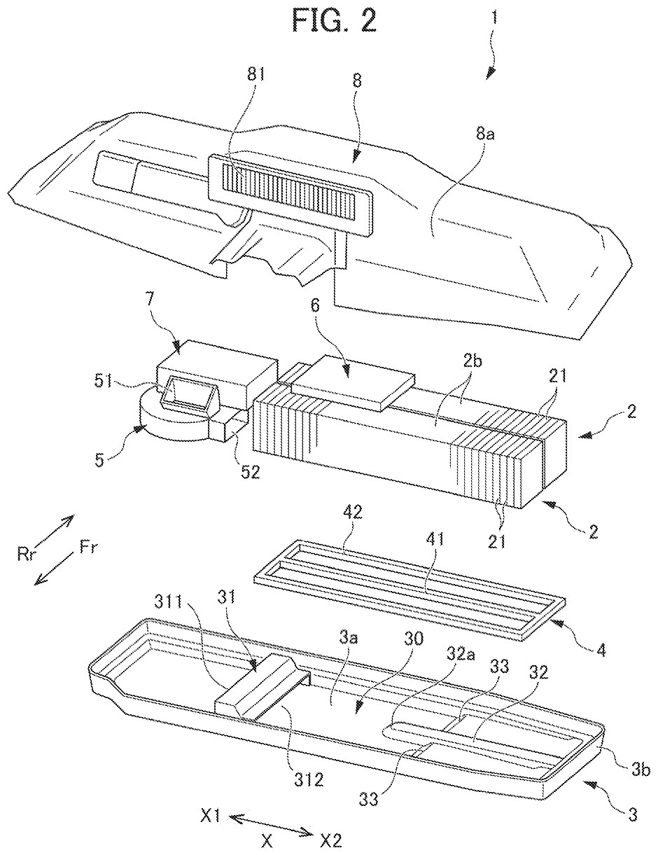

As illustrated in FIG. 2, the battery device 1 has cell stacked bodies 2, a base plate 3, a sealing material 4, a fan 5, an intelligent power unit (IPU) 6, a joint box 7, and a cover 8. Note that parts such as a harness for electrically connecting the components in the battery device 1 are omitted from the drawings.

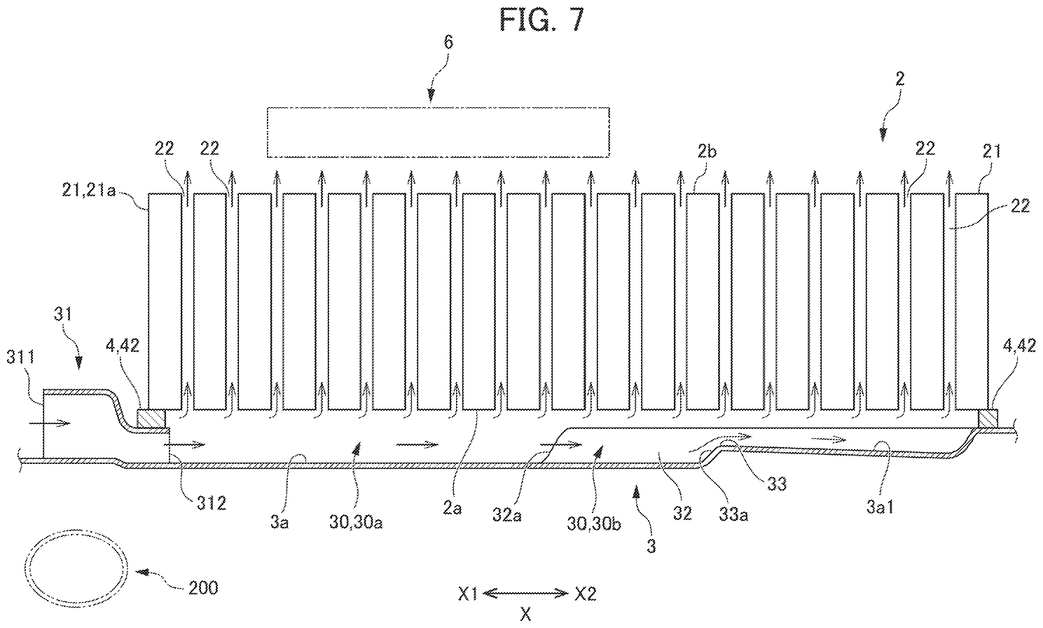

Each cell stacked body 2 includes a plurality of battery cells 21 with rectangular parallelepiped shapes being stacked along one direction. Hereinafter, the one direction in which the plurality of battery cells 21 are stacked will be simply referred to as a “stacking direction”. In the battery device 1 according to the present embodiment, the stacking direction of the cell stacked body 2 is denoted as an X direction. The battery cells 21, 21 adjacent to each other in the stacking direction have a predetermined gap interposed therebetween, whereby inter-cell flow paths 22 (see FIG. 7) through which cooling air flows in an upward direction are formed. The battery device 1 according to the present embodiment includes two cell stacking bodies 2, 2 with the same configuration. The two cell stacked bodies 2, 2 are arranged side by side such that the stacking direction follows the vehicle left-right direction.

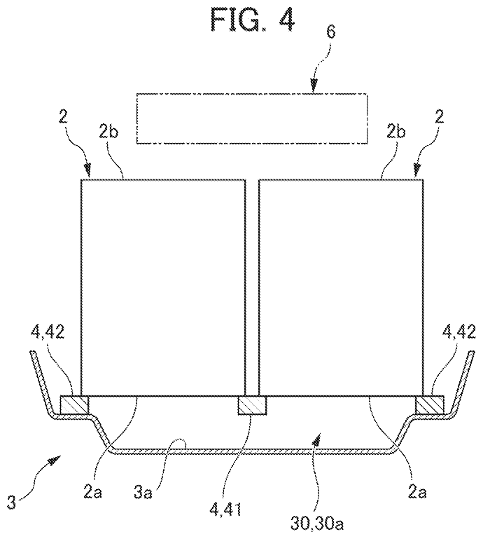

The base plate 3 is made of a metal plate molded into the shape of a substantially rectangular container having an upward opening. The base plate 3 has a length that is longer than the length of the cell stacked bodies 2 along the stacking direction and has a size allowing the two cell stacked bodies 2, 2, the fan 5, and the joint box 7 to be placed thereon. As illustrated in FIGS. 4 to 7, the base plate 3 is disposed adjacent to lower surfaces 2a, 2a of the cell stacked bodies 2, 2. The lower surface 2a is one surface of a plurality of surfaces of the cell stacked body 2 and extends along the stacking direction. The two cell stacked bodies 2, 2 are placed with a predetermined spacing therebetween over the base plate 3 via the sealing material 4.

An inflow-side flow path 30 configuring a flow path for cooling air is provided between a bottom portion upper surface 3a of the base plate 3 and the lower surfaces 2a, 2a of the cell stacked bodies 2, 2. The inflow-side flow path 30 extends in the stacking direction along the lower surfaces 2a, 2a of the cell stacked bodies 2, 2. The inflow-side flow path 30 and the inter-cell flow paths 22 of each of the cell stacked bodies 2, 2 communicate with each other.

The bottom portion upper surface 3a of the base plate 3 is provided with an air supply part 31. The air supply part 31 is disposed outside and near one end portion (an end portion in the X1 direction) in the stacking direction of the cell stacked bodies 2, 2. The air supply part 31 has an air intake port 311 connected to an exhaust duct 52 of the fan 5 and an air supply port 312 through which suctioned air is caused to flow out of the air supply part 31. The air supply port 312 is disposed in one end portion (an end portion in the X1 direction) of the inflow-side flow path 30 in the stacking direction. The air supply part 31 supplies cooling air generated through driving the fan 5 and suctioned from the air intake port 311 in a direction along both the lower surfaces 2a, 2a of the cell stacked bodies 2, 2 via the air supply port 312.

The sealing material 4 establishes sealing between the two cell stacked bodies 2, 2 and the inflow-side flow path 30. Specifically, the sealing material 4 has an inter-cell-stacked-body sealing portion 41 and an outer peripheral sealing portion 42. The inter-cell-stacked-body sealing portion 41 establishes sealing for preventing air flowing through the inflow-side flow path 30 from flowing out from between the cell stacked bodies 2, 2. The outer peripheral sealing portion 42 has a rectangular frame shape and establishes sealing for preventing the air flowing through the inflow-side flow path 30 from flowing out from an outer peripheral portion of the cell stacked bodies 2, 2.

The fan 5 is disposed on a side further from the cell stacked bodies 2 than the air supply part 31. When driven, the fan 5 blows out, from an exhaust duct 52 that communicates with the air intake port 311, the cooling air taken through an air intake duct 51 and supplies the cooling air to the inflow-side flow path 30 via the air supply part 31.

The IPU 6 is electrical equipment that controls inputs and outputs of the cell stacked bodies 2 and 2. The IPU 6 is disposed over upper surfaces 2b, 2b of the cell stacked bodies 2, 2 via a frame material (not illustrated) such that the IPU 6 lies across the two cell stacked bodies 2, 2. As illustrated in FIGS. 2 and 7, the TPU 6 is disposed near end portions of the upper surfaces 2b, 2b of the cell stacked bodies 2, 2, the end portions being adjacent to the air supply part 31 along the stacking direction.

As illustrated in FIG. 2, the joint box 7 establishes electrical connection between the battery device 1 and an external device. The joint box 7 is disposed above the fan 5.

The cover 8 is made of a metal plate molded into a substantially rectangular shape having a downward opening. The cover 8 has a size and a depth that allow the cover 8 to accommodate therein all the components of the battery device 1 in a state where the over 8 covers the entire base plate 3 from above. The cover 8 has a front surface 8a facing the vehicle front side and provided with an air intake portion 81 that takes air outside the battery device 1 to the inside of the cover 8. The air intake portion 81 communicates with the air intake duct 51 of the fan 5 inside the cover 8. The cover 8 is secured to the floor panel 100 with a fastening member (not illustrated) such as a bolt.

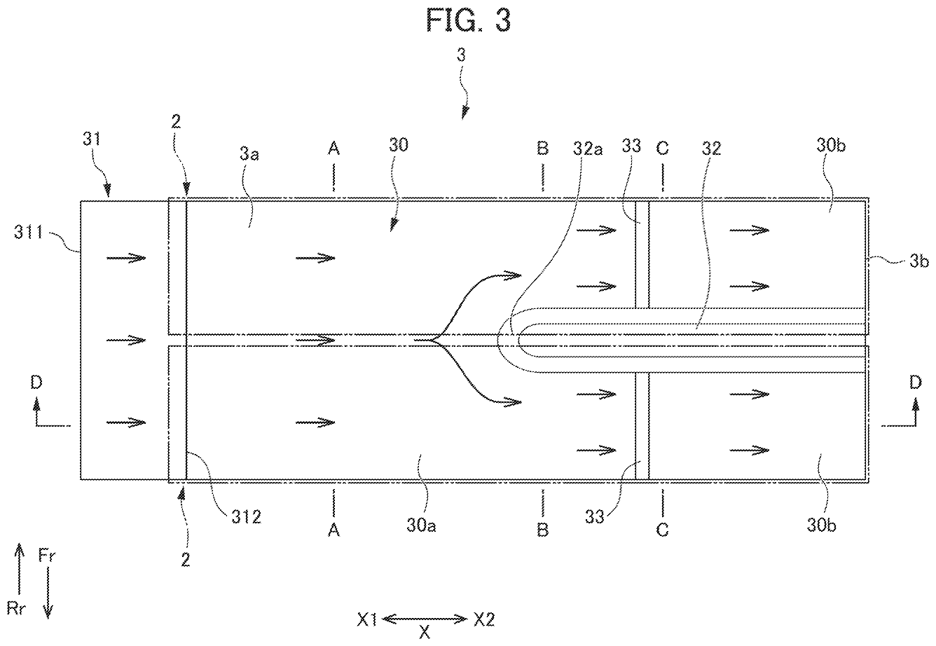

FIG. 3 illustrates the bottom portion upper surface 3a of the base plate 3. The inflow-side flow path 30 through which the cooling air flows is disposed between the bottom portion upper surface 3a and the cell stacked bodies 2, 2. The air supply port 312 is disposed at the left end portion of the inflow-side flow path 30 in the drawing. As indicated by the arrows in FIG. 3, the cooling air supplied from the air supply port 312 flows in the right direction through the inflow-side flow path 30 along the lower surfaces 2a, 2a of the cell stacked bodies 2, 2.

The bottom portion upper surface 3a of the base plate 3 is provided with a branching portion 32 protruding upward. The branching portion 32 is constituted by a protruding wall that has a substantially constant height and extends along the length direction (the left-right direction in FIG. 3) of the base plate 3. The branching portion 32 is disposed in a center portion of the base plate 3 in the width direction (the vertical direction in FIG. 3) in which the cell stacked bodies 2, 2 are arranged, and extends along the length direction of the base plate 3. The branching portion 32 has a width approximate to a distance by which the cell stacked bodies 2, 2 are spaced away from which other. Although the branching portion 32 of the present embodiment is integrated with the bottom portion of the base plate 3, the branching portion 32 may be a component separate from the base plate 3 and attached to the bottom portion upper surface 3a of the base plate 3.

As illustrated in FIG. 7, the branching portion 32 has a leading end portion 32a that constitutes the most upstream portion of the branching portion 32. The leading end portion 32a of the branching portion 32 is located at a position that is further from the air supply port 312 than endmost battery cells 21a, 21a, which are the endmost battery cells of the cell stacked bodies 2, 2 adjacent to the air supply port 312. The leading end portion 32a of the branching portion 32 of the present embodiment is disposed near the center portion of the base plate 3 in the length direction. The branching portion 32 extends from a location near the center portion of the base plate 3 in the length direction to a downstream end portion 3b that is the endmost portion of the base plate 3 opposite to the air supply port 312. The inter-cell-stacked-body sealing portion 41 of the sealing material 4 is placed on the upper surface of the branching portion 32.

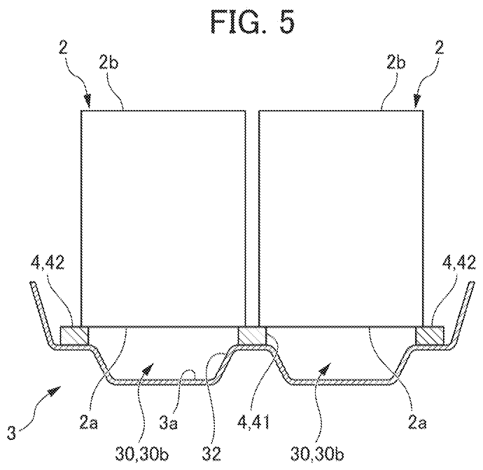

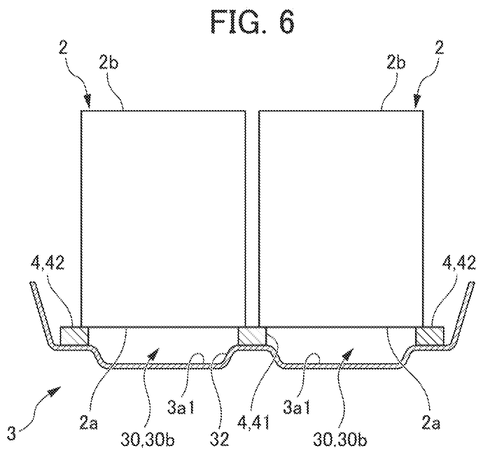

The branching portion 32 divides the inflow-side flow path 30 into two paths in the width direction of the base plate 3. Specifically, the inflow-side flow path 30 on the upstream side of the branching portion 32 is constituted by one common flow path 30a that is common to the two cell stacked bodies 2, 2 as illustrated in FIG. 4. On the other hand, the inflow-side flow path 30 on the downstream side of the branching portion 32 is divided by the branching portion 32 and the inter-cell-stacked-body sealing portion 41 of the sealing material 4 as illustrated in FIGS. 5 and 6. Thereby, the inflow-side flow path 30 on the downstream side of the branching portion 32 is constituted by two individual flow paths 30b, 30b associated with the two cell stacked bodies 2, 2, respectively.

The air flowing through the inflow-side flow path 30 in the left-to-right direction in FIG. 3 passes through the common flow path 30a while being in contact with both the lower surfaces 2a, 2a of the two cell stacked bodies 2, 2, and is then branched into two flows by the branching portion 32. The two flows of air branched by the branching portion 32 flow through the individual flow paths 30b and 30b while being in contact with the lower surfaces 2a, 2a of the cell stacked bodies 2, 2, respectively.

FIG. 4 illustrates a flow path cross-sectional area of the inflow-side flow path 30 (common flow path 30a) near the air supply port 312 located upstream of the branching portion 32. FIG. 5 illustrates a flow path cross-sectional area of the inflow-side flow path 30 (individual flow paths 30b, 30b) located downstream of the branching portion 32. As can be seen, the flow path cross-sectional area illustrated in FIG. 4 is greater than that illustrated in FIG. 5 due to the branching portion 32 disposed in the inflow-side flow path 30.

As a result, the air in the inflow-side flow path 30 (common flow path 30a) near the air supply port 312 flows at a lower flow rate and has a smaller pressure loss in comparison with the air in the inflow-side flow path 30 (individual flow paths 30b and 30b) after being branched by the branching portion 32.

Consequently, the air in the inflow-side flow path 30 (common flow path 30a) near the air supply port 312 has a high static pressure, and part of the air with the high static pressure is likely to flow into the inter-cell flow paths 22 above the inflow-side flow path 3 as well. The air in the inflow-side flow path 30 (individual flow paths 30b and 30b) after being branched by the branching portion 32 flows into the inter-cell flow paths 22 above the inflow-side flow path 30 in the course of flowing to the downstream end portion 3b of the base plate 3 along the length direction of the base plate 3. The air that has flowed into the inter-cell flow paths 22 cools the battery cells 21 in the course of flowing upward through the inter-cell flow paths 22 and then flows out upward from the upper surfaces 2b, 2b of the cell stacked bodies 2, 2.

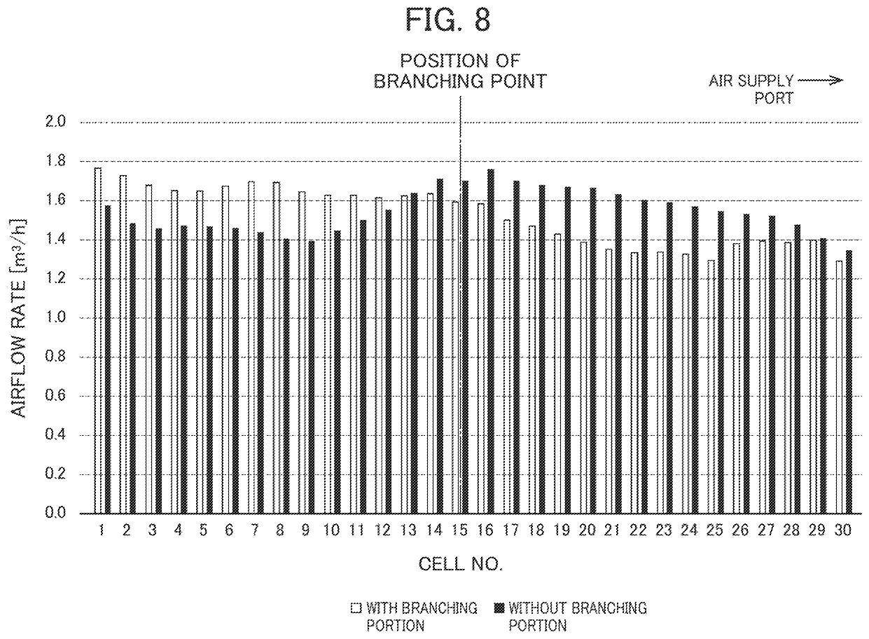

In this manner, the cooling structure provided in the battery device 1 can facilitate the air flow into the inter-cell flow paths 22 near the air supply port 312 as well with the simple configuration in which the base plate 3 is provided with the branching portion 32. Reference is made to FIG. 8. In a case in which the branching portion 32 is not provided (before adjustment), the airflow rate of the air flowing into the inter-cell flow paths 22 of the cell stacked bodies 2, 2 decreases near the air supply port 312, whereas in a case in which the branching portion 32 is provided (after adjustment), the volume of airflow increases and is equalized as a whole. As a result, variation in temperatures of the plurality of battery cells 21 constituting the cell stacked bodies 2, 2 is curbed, and energy efficiency of the battery device 1 is improved.

As illustrated in FIGS. 2, 3, and 7, the base plate 3 of the present embodiment further has step portions 33, 33 protruding into the inflow-side flow path 30 from the bottom portion upper surface 3a toward the cell stacked bodies 2, 2. The step portions 33, 33 are disposed at positions that are further from the air supply port 312 than the leading end portion 32a of the branching portion 32. The step portions 33, 33 are disposed at the individual flow paths 30b, 30b, respectively. The step portions 33, 33 of the present embodiment are disposed at positions that are slightly toward the leading end portion 32a of the branching portion 32 with respect to the center of the individual flow paths 30b, 30b in the length direction of the base plate 3.

The step portions 33, 33 extend in the width direction of the base plate 3 in the individual flow paths 30b, 30b such that the step portions 33, 33 perpendicularly intersect the flowing direction of the air flowing through the inflow-side flow path 30. Although the step portions 33, 33 of the present embodiment are integrated with the bottom portion of the base plate 3, the step portions 33, 33 may be components separate from the base plate 3 and attached to the bottom portion upper surface 3a of the base plate 3.

As illustrated in FIG. 7, the step portion 33, 33 are smaller in height than the branching portion 32. A surface 33a of the step portion 33 against which the air branched by the branching portion 32 collides is an inclined surface that is inclined downstream toward the top of the step portion 33. A bottom portion upper surface 3al of the base plate 3 located downstream of the step portion 33 is an inclined surface that is gently inclined downward in a direction form the step portion 33 to the downstream end portion 3b of the base plate 3.

The air immediately after passing through the leading end portion 32a of the branching portion 32 tends to flow less easily into the inter-cell flow paths 22 because of peeling-off of flow due to a change in flow direction caused by collision against the leading end portion 32a and because of an increase in flow rate caused by a decrease in flow path cross-sectional area. However, providing the step portions 33, 33 at the positions that are further from the air supply port 312 than the leading end portion 32a of the branching portion 32 makes it possible to direct the air near the leading end portion 32a of the branching portion 32 to the inter-cell flow paths 22. Therefore, the situation in which part of the air immediately after passing through the leading end portion 32a of the branching portion 32 is unlikely to flow into the inter-cell flow paths 22 is improved. In this manner, variation in temperatures of the plurality of battery cells 21 constituting the cell stacked bodies 2, 2 is further curbed.

Incidentally, the IPU 6 is disposed at a position that is closer to the air supply port 312 than the leading end portion 32a of the branching portion 32 of the base plate 3, as illustrated in FIGS. 2 and 7. Since the IPU 6 is a heat generating element that generates heat when an operating, there is a concern that the battery cells 21 at a position close to the air supply port 312 may be affected by heat. In this respect, according to the battery cooling structure of the present embodiment, the air easily flows also into the inter-cell flow paths 22 at a position that is close to the air supply port 312, thereby making it possible to suitably cool the battery cells 21 near the IPU 6. Therefore, the effect of heat exerted by the IPU 6, which is a heat generating element, on the battery cells 21 is reduced.

As illustrated in FIG. 1, an exhaust pipe 200 coupled to an engine (not illustrated) disposed in a front portion of the vehicle is laid on the lower surface of the floor panel 100. The exhaust pipe 200 extends from the front side to the rear side of the floor panel 100. The exhaust pipe 200 extends rearward along a tunnel portion 101 disposed in the front portion of the floor panel 100 and passes below the battery device 1. The exhaust pipe 200 is laid such that it is positioned opposite to the cell stacked bodies 2, 2 of the battery device 1 with respect to the base plate 3 and intersect the stacking direction.

As illustrated in FIG. 7, the exhaust pipe 200 below the battery device 1 is at a position that is closer to the air supply port 312 than the leading end portion 32a of the branching portion 32 of the base plate 3. Since the exhaust pipe 200 is a heat generating element that generates heat due to heat of exhaust gas, there is a concern that the battery cells 21 at a position close to the air supply port 312 may be affected by heat. In this respect, according to the battery cooling structure of the present embodiment, the air easily flows also into the inter-cell flow paths 22 at a position close to the air supply port 312, thereby making it possible to suitably cool the battery cells 21 near the exhaust pipe 200. Therefore, the effect of heat exerted by the exhaust pipe 200, which is a heat generating element, on the battery cell 21 is reduced.

As described above, the battery cooling device according to the present embodiment provides the following advantages. The battery cooling device according to the present embodiment includes: the cell stacked bodies 2, 2 that include a plurality of battery cells 21 stacked on each other and the inter-cell flow paths 22 between the battery cells 21, 21 that are adjacent to each other in the stacking direction of the plurality of battery cells 21; the base plate 3 that is disposed adjacent to the lower surfaces 2a, 2a of the cell stacked bodies 2; the inflow-side flow path 30 that is disposed between the cell stacked bodies 2, 2 and the base plate 3 and communicates with the inter-cell flow paths 22; and the air supply port 312 that is disposed in one end portion of the inflow-side flow path 30 in the stacking direction and supplies air to the inflow-side flow path 30. The base plate 3 has the branching portion 32 that branches air in the inflow-side flow path 30 flowing along the stacking direction from the air supply port 312, into a plurality of flows. The branching portion 32 is disposed at a position that is further from the air supply port 312 than the endmost battery cells 21a of the cell stacked bodies 2, 2, the endmost battery cells 21a being adjacent to the air supply port 312. Due to this configuration, in the inflow-side flow path 30, the flow path cross-sectional area near the air supply port 312 on the upstream side is greater than the flow path cross-sectional area on the downstream side of the branching portion 32, air in the inflow-side flow path 30 near the air supply port 312 has a low flow rate and a smaller pressure loss. Therefore, the air easily flows into the inter-cell flow paths 22 near the air supply port 312. Consequently, it is possible to curb variation in temperatures of the battery cells 21 and thereby to improve energy efficiency of the battery device 1 with the simple configuration in which the base plate 3 is provided with the branching portion 32.

The base plate 3 of the present embodiment has the step portions 33, 33 protruding into the inflow-side flow path 30 toward the cell stacked bodies 2, 2. The step portions 33, 33 are disposed at the positions that are further from the air supply port 312 than the branching portion 32. This configuration makes it possible to improve the situation in which the air does not easily flow into the inter-cell flow paths 22 near the leading end portion 32a of the branching portion 32 due to peeling-off of airflow caused near the branching portion 32 and an increase in flow rate due to a decrease in flow path cross-sectional area. Consequently, the air easily flows into the inter-cell flow paths 22 near the leading end portion 32a of the branching portion 32 as well, thereby making it possible to further curb the variation in temperatures of the battery cells 21.

The plurality of cell stacked bodies 2, 2 of the present embodiment are arranged side by side on the base plate 3. The inflow-side flow path 30 is common to by the plurality of cell stacked bodies 2, 2. The branching portion 32 is disposed between the adjacent cell stacked bodies 2, 2. This configuration makes it possible to curb the variation in temperatures of the battery cells 21 for each of the plurality of cell stacked bodies 2, 2.

In the present embodiment, the IPU 6 that controls inputs and outputs of the cell stacked bodies 2, 2 is disposed opposite to the base plate 3 with respect to the cell stacked bodies 2, 2. The IPU 6 is disposed at a position that is closer to the air supply port 312 than the branching portion 32 of the base plate 3. The battery cooling structure of the present embodiment makes it possible to suitably cool the battery cells 21 disposed at a position that is close to the air supply port 312 and thereby to reduce an effect of heat exerted on the battery cells 21 even if the IPU 6, which is a heat generating element, is disposed at a position close to the air supply port 312.

In the present embodiment, the engine exhaust pipe 200 is disposed opposite to the cell stacked bodies 2, 2 with respect to the base plate 3, and intersects the stacking direction. The exhaust pipe 200 is disposed at a position closer to the air supply port 312 than the branching portion 32 of the base plate 3. The battery cooling structure of the present embodiment makes it possible to suitably cool the battery cells 21 disposed at a position close to the air supply port 312 and thereby to reduce an effect of heat exerted on the battery cells 21 even if the exhaust pipe 200, which is a heat generating element, is disposed at a position close to the air supply port 312.

Although the battery device 1 described in the above embodiment has the cell stacked bodies 2, 2 arranged in two lines on the base plate 3, the cell stacked bodies 2 may be arranged in three or more lines on the base plate 3, or the cell stacked body 2 may be disposed only in one line on the base plate 3.

### EXPLANATION OF REFERENCE NUMERALS

1 Battery device
2 Cell stacked body
2a Lower surface of cell stacked body
21 Battery cell
21a Battery cell located at furthest end portion on side of air supply port
22 Inter-cell flow path
3 Base plate
30 Inflow-side flow path
312 Air supply port
32 Branching portion
33 Step portion
6 IPU (electrical equipment)
200 Exhaust pipe

What is claimed is:

1. A battery cooling structure comprising:
a cell stacked body that includes a plurality of battery cells stacked on each other and an inter-cell flow path between the battery cells that are adjacent in a stacking direction of the plurality of battery cells;
a base plate that is disposed adjacent to one of surfaces of the cell stacked body, the surfaces extending along the stacking direction;
an inflow-side flow path that is disposed between the cell stacked body and the base plate and communicates with the inter-cell flow path; and
an air supply port that is disposed in one end portion of the inflow-side flow path in the stacking direction and supplies air to the inflow-side flow path,
wherein the base plate has a branching portion that branches the air in the inflow-side flow path flowing along the stacking direction from the air supply port, into a plurality of flows, and
the branching portion is disposed at a position that is further from the air supply port than one endmost battery cell among the battery cells of the cell stacked body, the one endmost battery cell being adjacent to the air supply port.

2. The battery cooling structure according to claim 1,
wherein the base plate has a step portion that protrudes into the inflow-side flow path toward the cell stacked body, and
the step portion is disposed at a position that is further from the air supply port than the branching portion.

3. The battery cooling structure according to claim 1,
wherein the cell stacked body comprises a plurality of cell stacked bodies arranged side by side on the base plate,
the inflow-side flow path is common to the plurality of cell stacked bodies, and
the branching portion is disposed between the cell stacked bodies that are adjacent to each other.

4. The battery cooling structure according to claim 1, further comprising electrical equipment that controls an input and an output of the cell stacked body and is disposed opposite to the base plate with respect to the cell stacked body,
wherein the electrical equipment is disposed at a position that is closer to the air supply port than the branching portion of the base plate.

5. The battery cooling structure according to claim 1,
wherein the battery cooling structure is adapted to be installed such that the cell stacked body is positioned opposite to an engine exhaust pipe with respect to the base plate while having the stacking direction intersecting the engine exhaust pipe, and
the exhaust pipe is disposed at a position that is closer to the air supply port than the branching portion of the base plate.
